(19) United States
(12) Patent Application Publication
(10) Pub. No.: US 2008/0263918 A1
(43) Pub. Date: Oct. 30, 2008

(54) Apparatus and Method for Merchandising on a beverage dispenser and beverage dispensing system incorporating the same

(76) Inventor: Jeffrey Doughty, Glennelg, MD (US)

Correspondence Address: CHERNOW KATZ, LLC, 721 DRESHER RD, SUITE 1100, HORSHAM, PA, 19044, US

(21) Appl. No.: 12/108,703

(22) Filed: Apr. 24, 2008

Related U.S. Application Data
(60) Provisional application No. 60/913,838, filed on Apr. 25, 2007.

(51) Int. Cl. G09F 1/00; A47G 29/00; G09F 3/18

(52) U.S. Cl. 40/124.03; 40/124.06; 40/657; 40/642.02

(57) ABSTRACT

A merchandising apparatus and method for use in conjunction with a beverage dispenser, such as a water cooler, and a beverage dispensing system utilizing the same. In one aspect the invention is a merchandising apparatus for mounting to a beverage dispenser comprising: a center panel having a bottom edge, a top edge, a first lateral edge, a second lateral edge, a front surface and a rear surface; a first flange extending from one of the front or rear surfaces of the center panel; a first side panel connected to the first lateral edge of the center panel, the first side panel extending below the bottom edge of the center panel; and a second side panel connected to the second lateral edge of the center panel, the second side panel extending below the bottom edge of the center panel. In another embodiment, the invention is beverage dispensing system comprising: a housing having a conduit operably connected to a source of a beverage, the housing having a top surface and lateral surfaces; an apparatus comprising: a center panel having a bottom edge, a top edge, a first lateral edge, a second lateral edge, a front surface and a rear surface; a first flange extending from one of the front or rear surfaces of the center panel; a first side panel connected to the first lateral edge of the center panel, the first side panel extending below the bottom edge of the center panel; and a second side panel connected to the second lateral edge of the center panel, the second side panel extending below the bottom edge of the center panel; and the apparatus operably positioned on the housing so that a bottom surface of the first flange contacts the top surface of the housing and supports the apparatus so that the center panel is in a substantially upright position above the top surface of the housing and the first and second side panels extend downward and adjacent to the lateral surfaces of the housing.

### CROSS-REFERENCE TO RELATED PATENT APPLICATIONS

The present application claims the benefit of U.S. Provisional Application 60/913,838, filed Apr. 25, 2007, the entirety of which is hereby incorporated by reference in its entirety.

### FIELD OF THE INVENTION

The present invention relates generally to apparatus, systems and methods for advertising on beverage dispensers, and specifically to advertising apparatus in combination with beverage dispensers. Still more particularly, the present invention is particularly suited for use or in combination with water coolers.

### BACKGROUND OF THE INVENTION

Various types of beverage dispensers are commonly used to dispense a wide variety of beverages, including water, soda, juices, etc. Soda dispensers typically provide multiple types of soda and are dimensionally the largest of the beverage dispensers. Juice dispensers also typically provide multiple types of juice and are often the same size as soda dispensers. On the other hand, water dispensers dispense only one beverage, water, and thus are substantially smaller in size than the soda and juice dispensers. A typical water cooler is illustrated in FIG. 1

For obvious reasons, beverage machines having a larger surface area can communicate more effectively with potential consumers and attract more attention than their smaller counterpart. As many cafeterias and dining halls are considerable in size, often capable of holding hundreds of people, the ability to attract consumer attention to any particular beverage dispenser depends on its physical size. To this extent, the large physical size of soda and juice machines provide a means by which consumers can quickly identify the location of the soda and juice machines, often leading to the consumers choosing soda and juice as their drinking beverage. To the contrary, due to their small size, consumers may not be able to find water coolers even when looking specifically for them.

This problem for water dispensers is further exasperated by the fact that the large soda and juice machines are also covered with attention grabbing visuals and merchandising content. While attempts have been made to communicate and/or merchandise on water dispensers, all of these attempts have utilized the surface area provided by the water dispenser's housing or the water bottle itself, thereby failing to increase the overall visible surface area of the water dispensing system, rendering the water dispenser still small in stature and inadequate for communication or advertising.

Facilities such as cafeterias and dining halls which provide buffet style meals at one price, also known as all-you-can-eat, make a profit assuming the cost of the food and beverages consumed are less than the cost of admittance. Thus, the goal of such facilities is to achieve the greatest possible profit by decreasing the cost of food and beverages consumed per patron, thereby increasing the profit margin. One method of manipulating this profit margin is by attempting to attract diners to the food and beverage items that have the lowest cost.

Interchangeable items with large disparities in cost, such as beverages, are effective for reducing the overall cost per patron if the lower cost alternative is selected more often. The disparities in the per unit cost of juice and soda is considerably higher than the cost of water, either bottled or from a water cooler. Attracting patrons to the lower cost water alternative has had challenges.

As alluded to above, existing water dispenser displays are located on the water cooler housing itself and do not increase the chances of the water cooler being discovered and therefore utilized more often. Instead, such displays are used to merely communicate to those who already use the water cooler and do not proactively recruit more users of water.

Therefore, a need exists to increase the desirability or attractiveness of water as an alternative to other beverages, thereby decreasing the overall cost of beverages per patron and increasing the profit margin. A need also exists to increase the visibility of water dispensers in large and/or crowded facilities.

Until the present invention increasing the consumption of beverages having the lowest per unit cost has been evasive, and therefore the foregoing needs and problems had not been met or solved. Thus, it remains a requirement in the art to provide a display that can convert soda and juice drinkers to water drinkers as will be discussed in more detail below.

### SUMMARY OF THE INVENTION

The aforementioned needs and other needs are met by the present invention which increases the surface area and physical size of a beverage dispenser, which in a preferred embodiment is a water dispenser. The resulting increased surface area and size of the beverage dispenser not only makes the beverage dispenser easier to locate but also can be used for merchandising, including advertising.

In one aspect, the invention can be a merchandising apparatus for mounting to a beverage dispenser comprising: a center panel having a bottom edge, a top edge, a first lateral edge, a second lateral edge, a front surface and a rear surface; a first flange extending from one of the front or rear surfaces of the center panel; a first side panel connected to the first lateral edge of the center panel, the first side panel extending below the bottom edge of the center panel; and a second side panel connected to the second lateral edge of the center panel, the second side panel extending below the bottom edge of the center panel.

The use of the inventive merchandising apparatus easily and cheaply increases the surface area of a beverage dispenser, thereby creating a physical presence for smaller dispensers, such as water dispensers, as large as or even larger than other beverage dispensers, such as soda and juice dispensers. In some embodiments, the merchandizing apparatus may have clear pockets on one or more of the panels for allowing merchandising materials, such as products, samples, and other advertising items to be displayed and or offered. These pockets allow the merchandising materials to be removed and replaced easily, quickly, efficiently, and cheaply at any time. Thus, an additional source of potential revenue for the beverage dispenser is created. This innovative revenue generating concept allows a simple water cooler to transform into an interactive media board.

In another aspect, the present invention can be a beverage dispensing system comprising: a housing having a conduit operably connected to a source of a beverage, the housing having a top surface and lateral surfaces; an apparatus comprising: a center panel having a bottom edge, a top edge, a first lateral edge, a second lateral edge, a front surface and a rear surface; a first flange extending from one of the front or rear surfaces of the center panel; a first side panel connected to the first lateral edge of the center panel, the first side panel extending below the bottom edge of the center panel; and a second side panel connected to the second lateral edge of the center panel, the second side panel extending below the bottom edge of the center panel; and the apparatus operably positioned on the housing so that a bottom surface of the first flange contacts the top surface of the housing and supports the apparatus so that the center panel is in a substantially upright position above the top surface of the housing and the first and second side panels extend downward and adjacent to the lateral surfaces of the housing.

In yet another aspect, the present invention can be a method of merchandising on a beverage dispenser comprising: providing an apparatus for mounting to a beverage dispenser comprising a center panel having a bottom edge, a top edge, a first lateral edge, a second lateral edge, a front surface and a rear surface; a first side panel connected to the first lateral edge of the center panel, the first side panel extending below the bottom edge of the center panel; a second side panel connected to the second lateral edge of the center panel, the second side panel extending below the bottom edge of the center panel; and positioning the apparatus on the beverage dispenser; and displaying merchandising content on at least one of the center panel, the first side panel or the second side panel for a beverage dispensed by the beverage dispenser.

In a further embodiment of the invention, a merchandiser display is removably attached to a water cooler, thereby providing a larger surface area and a uniquely shaped surface area. This surface area may be used for merchandising, such as communications to attract consumers and increase their preference and conversion to drinking water over other beverages.

### BRIEF DESCRIPTION OF THE DRAWINGS

A more complete appreciation of the invention and many of the attendant advantages thereof will become better understood when referring to the accompanying drawings wherein:

FIG. 1 is a front perspective view of a prior art stand-alone water cooler

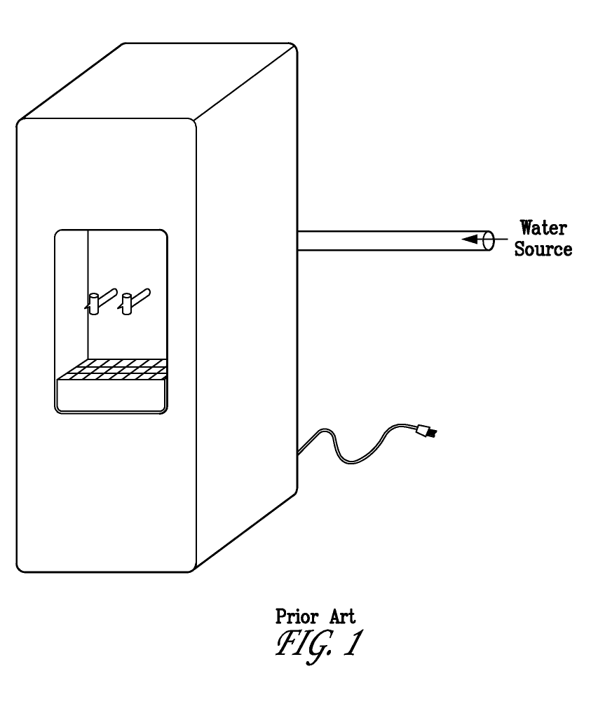

FIG. 2 is a front perspective view of a merchandising apparatus according to one embodiment of the present invention.

FIG. 3 is a rear perspective view of diagram of the merchandising apparatus of FIG. 1.

FIG. 4 is a cross-sectional view of the merchandising apparatus of FIG. 2 along line IV-IV.

FIG. 5 is a front perspective view of a beverage dispensing system according to one embodiment of the present invention.

FIG. 6 is a rear perspective view of the beverage dispensing system of FIG. 5.

### DETAILED DESCRIPTION OF THE DRAWINGS

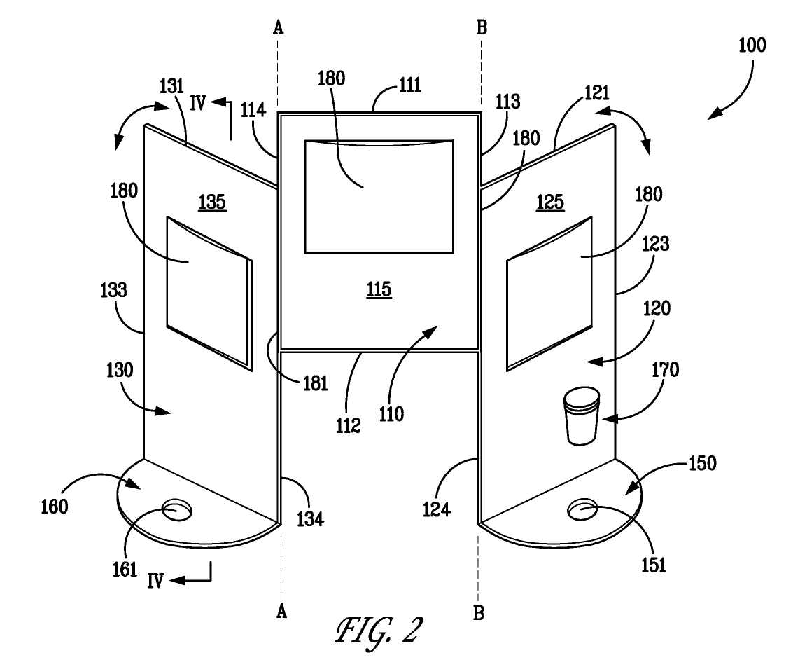

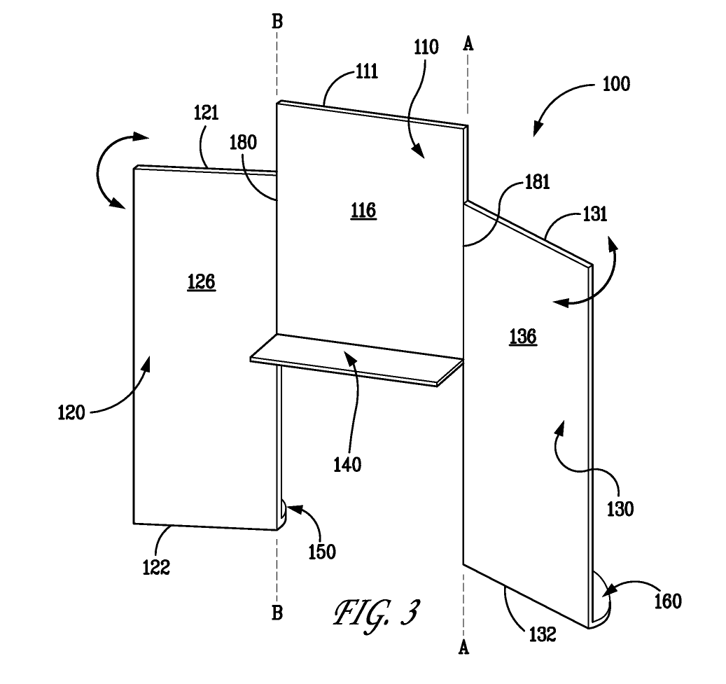

Referring first to FIGS. 2-3 concurrently, a merchandising apparatus 100 according to an embodiment of the present invention is illustrated. The merchandising apparatus 100 generally comprises a center panel 110, a right side panel 120 and a left side panel 130. The merchandising apparatus 100 also comprises a mounting flange 140 and cup-holder flanges 150, 160. Of course, alternative embodiments of the invention may comprises more or less panels and/or flanges as desired.

The center panel 110 comprises a top edge 111, a bottom edge 112, a left lateral edge 113 and a right lateral edge 114. The right-side panel 120 comprises a top edge 121, a bottom edge 122, a right lateral edge 123 and a left lateral edge 124 (which in this embodiment is integral with the right lateral edge 114 of the center panel 110 for a portion). The left-side panel 130 comprises a top edge 131, a bottom edge 132, a left lateral edge 133 and a right lateral edge 134 (which in this embodiment is integral with the left lateral edge 113 of the center panel 110 for a portion).

The center panel 110 also comprises a front major surface 115 and a rear major surface 116. The right-side panel 120 also comprises a front major surface 125 and a rear major surface 126. Similarly, the left-side panel 130 also comprises a front major surface 135 and a rear major surface 136. It should be noted that while the panels 110, 120, 130 are generally rectangular in shape in the illustrated embodiment, the invention is not so limited and can take on any desired shape.

The right-side panel 120 is connected to the right lateral edge 113 of the center panel 110 and is oriented so that its front surface 125 angles backward and away from the front surface 115 of the center panel 110. Similarly, the left-side panel 130 is connected to the left lateral edge 114 of the center panel 110 and is also oriented so that its front surface 135 angles backward and away from the front surface 115 of the center panel 110 (in a mirror-image of the right-side panel 120).

The right-side panel 120 is pivotally connected to the center panel 110 so as to be pivotable about axis B-B while left-side panel 130 is pivotally connected to the center panel 110 so as to be pivotable about axis A-A. More specifically, the left lateral edge 124 of the right-side panel 120 is pivotally connected to the right lateral edge 113 of the center panel 110 via a first crease 180 formed into the merchandising apparatus 100. Similarly, the right lateral edge 134 of the left-side panel 130 is pivotally connected to the left lateral edge 114 of the center panel 110 via a second crease 181 formed into the merchandising apparatus 100.

While the pivotal connection between the right and left side panels 120, 130 and the center panel 110 is facilitated by creases 180, 181 in the illustrated embodiment, the invention is not so limited. Depending on the structural details of the merchandising apparatus 100 the pivotable connections can be accomplished in a wide variety of ways, including without limitation the use of hinges, swivels, etc. Furthermore, in some embodiments of the invention, the connection between the between the right and left side panels 120, 130 and the center panel 110 may not be pivotable in nature but fixed.

The left and right side panels 120, 130 are connected to the center panel 110 so that they extend below the bottom edge 112 of the center panel 110. This creates a volume (or area) below the center panel 110 and between the left and right side panels 120, 130 for a beverage dispenser. The top edges 121, 131 of the left and right side panels 120, 130 are below the top edge 111 of the center panel 110. The invention is not so limited. In other embodiments, the left and right side panels 120, 130 may be positioned at different relative heights and be different relative sizes as compared to the center panel 110.

The merchandising apparatus 100 also comprises a mounting flange 140 connected to the bottom edge 112 of the center panel 110. The mounting flange 140 extends outward from the rear major surface 116 of the center panel 110 at an approximately 90 degree angle. As will become apparent from the below discussion of the inventive beverage dispensing system, the mounting flange 140 serves as a support structure for the merchandising apparatus 100 atop a beverage dispenser. More specifically, the mounting flange 140 supports the merchandising apparatus 100 atop a beverage dispenser so that the center panel 110 (and as a result the side panels 120, 130) is in a substantially upright orientation.

While the mounting flange 140 is located along the bottom edge of the center panel 110 and extending rearward in the illustrated embodiment, the invention is not so limited. For example, in alternative embodiments the mounting flange can extend from the center panel at different heights and/or can even extend from the front surface of the center panel. In even other embodiments, the mounting flange may be located on the one or more of the side panels instead of or in addition to the center panel. The mounting flange 140 may also be a separate structure secured to the one or more of the panels 110, 120, 130.

Furthermore, while a simple mounting flange 140 is the preferred mechanism for achieving removable non-fixed mounting of the merchandising apparatus 100 on the beverage dispenser, the invention is not so limited. Depending on the users' preferences, a wide variety of means can be used to secure or otherwise mount the merchandising apparatus 100 to the beverage dispenser. For example, simple holes can be supplied in the panels 110, 120, 130 for screwing, bolting, hooking or otherwise fastening the merchandising apparatus 100 to the beverage dispenser. In even further embodiments, adhesives, double-sided tap, clamps, snaps, buckles, hook-and-loop fastener tape, magnets or the like may be used to fasten the merchandising apparatus 100 to the beverage dispenser. Moreover, any of these mechanisms can be used instead of or in conjunction with the mounting flange 140.

Referring now to FIG. 2, the merchandising apparatus 100 also comprises cup-holder flanges 150, 160. The first cup-holder flange 150 extends from the front surface 125 of the right-side panel 120 at an approximately 90 degree angle. Similarly, the second cup-holder flange 160 extends from the front surface 135 of the left-side panel 130 at an approximately 90 degree angle. The cup-holder flanges 150, 160 are at the bottom edges 122, 132 of the right and left side panels 120, 130 but can be located at other positions, including on the center panel 110, at other locations on the side panels 120, 130 and at different angles.

Holes 151, 161 are provided in the first and second cup-holder flanges 150, 160. Each of the holes 151, 161 are sized and shaped to slidably receive and support a stack of cups 170. Further, the flanges 150, 160 may be used to hold items such as lemon or lime wedges, and may even have built in cups for holding such items.

In a preferred embodiment of the invention, the panels 110, 120, 130 and flanges 140, 150, 160 of the merchandising apparatus 100 are constructed from a single piece/sheet of material that is bent or creased to create the desired three-dimensional geometry of the merchandising apparatus 100. Suitable materials include without limitation, sheet, cardboard, plastics, flexible foam board, etc. Of course, the invention is not so limited and the merchandising apparatus 100 can be constructed from a plurality of component panels and other materials.

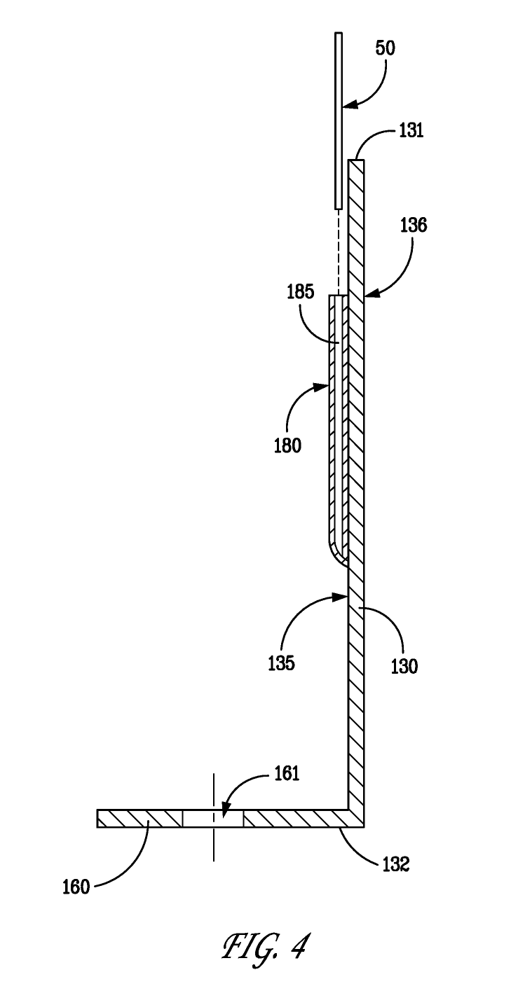

Referring now to FIGS. 2 and 4 concurrently, the merchandising apparatus 100 also comprises clear pockets 180 connected to the front surfaces 125, 115, 135 of the panels 120, 110, 130. The clear pockets 180 form cavities 185 for slidably receiving merchandising material 50, such as an advertising flyer or the like. Of course, the clear pockets 180 can be sized and shaped to receive any kind of merchandising material 50 and are not limited to holding sheets or flat merchandising materials. The merchandising material 50 may be easily inserted into and removed from the cavities 85 so that the exact content displayed can be rotated on a regular basis thereby providing a timely display without having to completely redesign the display. Merchandising offers or samples may also be provided in the pockets.

The pockets 180 are substantially clear so that the merchandising material 50 can be viewed therethrough. The clear pockets 180 can be formed of flexible plastic, rigid plastic, glass, or other materials. The clear pockets 180 can be secured to the panels 110, 120, 130 by a variety of methods including screws, bolts, adhesives, tape, heat welding, etc. The exact connection method will depend on the structural details of the pockets 180 and their material of construction.

While the illustrated structure for displaying merchandising material on the merchandising apparatus 100 are the clear pockets 180, the invention is not so limited. In other embodiments, the merchandising material can be supported on the front surfaces 115, 125, 135 of the panels 110, 120, 130 using a variety of structures, such as plates, trays, grooves, etc. Moreover, in some embodiments, the merchandising material may be secured directly to the panels 110, 120, 130 or can be integral therewith.

It is to be understood, that many alternatives exist for the means for displaying the merchandising content, including but not limited to computer monitors, liquid crystal displays, and other means of audio, video or image communication.

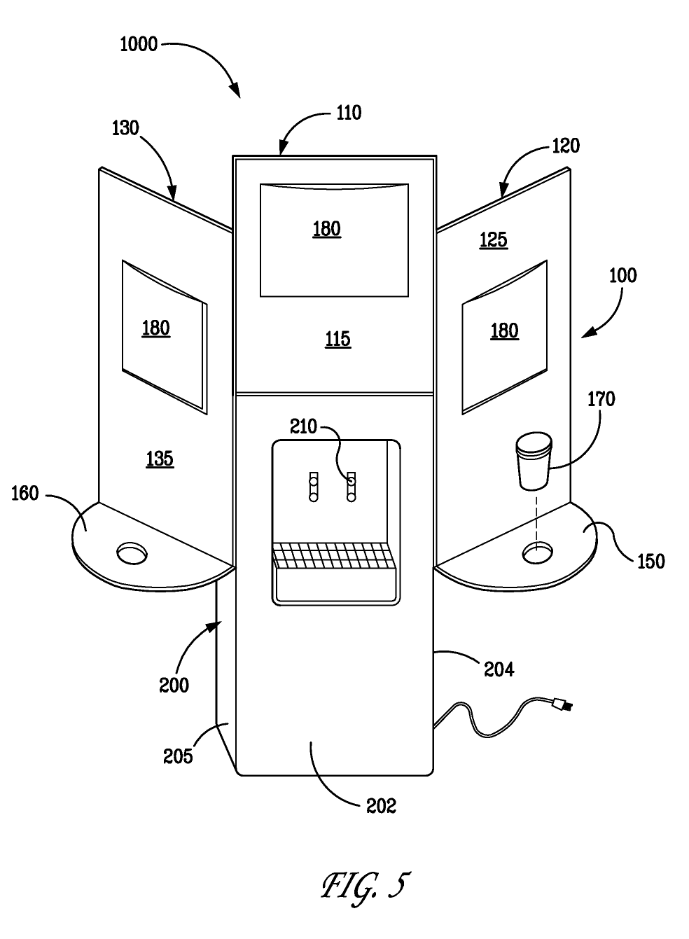

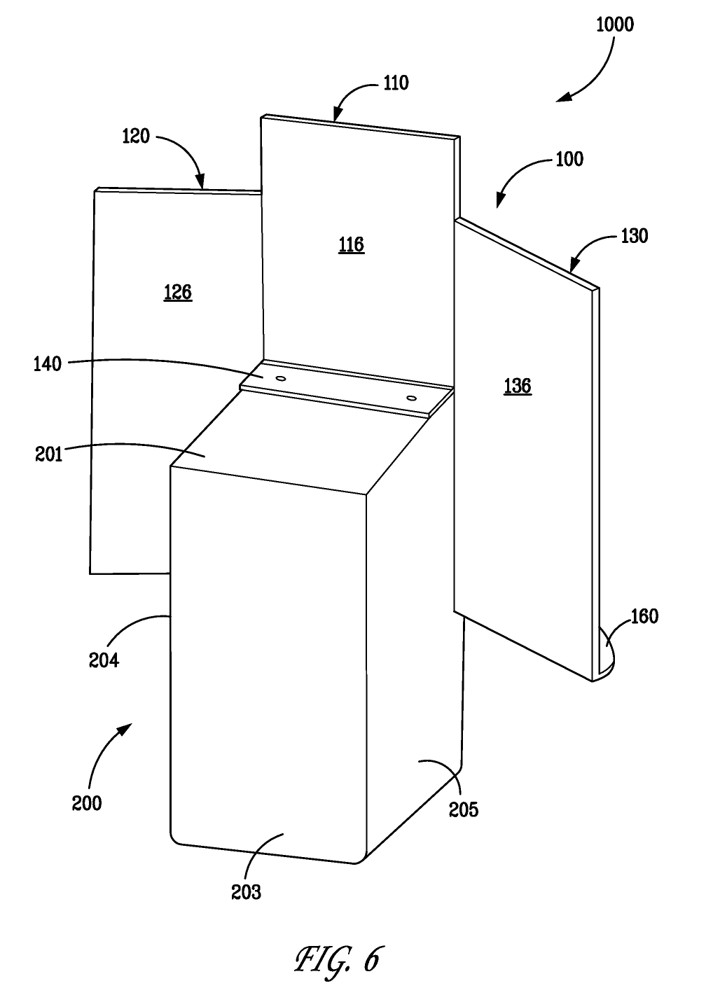

Referring now to FIGS. 5 and 6 concurrently, a beverage dispensing system 1000 is illustrated according to an embodiment of the present invention. The beverage dispensing system 1000 generally comprises a beverage dispenser 200, which is in the form of a water cooler, and the merchandising apparatus 100 discussed above in relation to FIGS. 2-4.

The water cooler 200 comprises a dispenser 210 that is operably coupled to a source of water, such as water bottle, tap water, or a centralized reservoir. The water cooler 200 has a main housing that comprises a top surface 201, front surface 202, rear surface 203 and lateral surfaces 204-205.

The merchandising apparatus 100 is mounted to the water cooler 200 as illustrated. Specifically, the merchandising apparatus 100 is positioned so that the bottom surface of the mounting flange 140 rests atop the top surface 201 of the water cooler 200. Screws are used to secure the mounting flange 140 to the water cooler 200. When in position, the center panel 110 is in a substantially upright orientation atop the water cooler's top surface 201 while the right and left side panels 120, 130 extend downward so as to be adjacent to the lateral surfaces 204, 205 of the water cooler housing. Merchandising material 50 is positioned in one or more of the clear pockets 180.

As can be seen, the front surfaces 115 125, 135 of the panels 110, 120, 130 increase the overall viewable surface of the water cooler 200 and thus the beverage dispensing system 1000. The merchandising apparatus 100 is easily and removably secured to the previously existing water cooler 100 negating the need to manufacturer a new water cooler.

Also in this embodiment, the merchandising display is a separately manufactured piece of material allowing for a variety of shapes, sizes, and material, allowing for increased visibility of the water cooler and the attraction of customers.

It should be noted that the present invention has been described in connection with the preferred embodiment. However, as one of ordinary skill in the art may appreciate, elements of the invention may be practiced individually or in various sub-combinations not including all of the elements of the preferred embodiment, and still fall within the spirit and scope of the present invention.

What is claimed is:

1. A merchandising apparatus for mounting to a beverage dispenser comprising:
a center panel having a bottom edge, a top edge, a first lateral edge, a second lateral edge, a front surface and a rear surface;
a first flange extending from one of the front or rear surfaces of the center panel;
a first side panel connected to the first lateral edge of the center panel, the first side panel extending below the bottom edge of the center panel; and
a second side panel connected to the second lateral edge of the center panel, the second side panel extending below the bottom edge of the center panel.

2. The merchandising apparatus of claim 1 wherein the first and second side panels are pivotally connected to the first and second lateral edges of the center panel.

3. The merchandising apparatus of claim 2 wherein the center panel, the first side panel and the second side panel are a single piece of material and the first and second side panels are pivotally connected to the center panel by creases in the single piece of material.

4. The merchandising apparatus of claim 1 wherein the first flange is connected to the bottom edge of the center panel and extending from the rear surface of the center panel.

5. The merchandising apparatus of claim 1 wherein the first and second side panels are pivotally connected to the first and second lateral edges of the center panel by one or more hinges.

6. The merchandising apparatus of claim 1 wherein at least one of the center panel, the first side panel or the second side panel comprises merchandising content.

7. The merchandising apparatus of claim 1 further comprising:
means on at least one of the center panel, the first side panel or the second side panel for non-fixedly supporting a merchandising material.

8. The merchandising apparatus of claim 7 wherein the means for non-fixedly supporting the merchandising material is selected from a group consisting of a piece of hook-and-loop fastener, a clear pocket, a magnetic member, a piece of double-sided tape,

9. The merchandising apparatus of claim 1 wherein each of the first side panel and the second side panel comprise a means for non-fixedly supporting a merchandising material.

10. The merchandising apparatus of claim 1 wherein at least one of the first side panel or the second side panel comprises means for holding a beverage container.

11. The merchandising apparatus of claim 1 further comprising a second flange extending from a front surface of at least one of the first side panel or the second side panel, the second flange comprising a hole sized and shaped to slidably receive and hold a beverage container.

12. The merchandising apparatus of claim 11 wherein each of the first side panel and the second side panel comprise one of the second flanges.

13. The merchandising apparatus of claim 1 further comprising a video, audio and/or image display device connected to at least one of the first side panel or the second side panel.

14. The merchandising apparatus of claim 1 further comprising:
the center panel, the first side panel and the second side panel being a single piece of material;
the first and second side panels being pivotally connected to the center panel by creases in the single piece of material;
the first flange being connected to the bottom edge of the center panel and extending from the rear surface of the center panel;
a clear pocket on a front surface of at least one of the first and second side panels;
a merchandising material in the clear pocket; and
a second flange connected to a bottom edge and extending from a front surface of at least one of the first or second side panels, the second flange comprising a hole sized and shaped to slidably receive and hold a beverage container.

15. A beverage dispensing system comprising:
a housing having a conduit operably connected to a source of a beverage, the housing having a top surface and lateral surfaces;
an apparatus comprising:
a center panel having a bottom edge, a top edge, a first lateral edge, a second lateral edge, a front surface and a rear surface;
a first flange extending from one of the front or rear surfaces of the center panel;
a first side panel connected to the first lateral edge of the center panel, the first side panel extending below the bottom edge of the center panel; and
a second side panel connected to the second lateral edge of the center panel, the second side panel extending below the bottom edge of the center panel; and
the apparatus operably positioned on the housing so that a bottom surface of the first flange contacts the top surface of the housing and supports the apparatus so that the center panel is in a substantially upright position above the top surface of the housing and the first and second side panels extend downward and adjacent to the lateral surfaces of the housing.

16. The beverage dispensing system of claim 15 wherein the apparatus further comprises a second flange extending from a front surface of at least one of the first side panel or the second side panel, the second flange comprising a hole; and at least one beverage container slidably inserted into the hole and supported thereby.

17. The beverage dispensing system of claim 15 wherein the apparatus comprises merchandising content on at least one of the center panel, the first side panel or the second side panel for the beverage.

18. The beverage dispensing system of claim 15 wherein the apparatus further comprises:
a second flange extending from a front surface of at least one of the first side panel or the second side panel, the second flange comprising a hole;
at least one beverage container slidably inserted into the hole and supported by the second flange;
the center panel, the first side panel and the second side panel being a single piece of material;
the first and second side panels being pivotally connected to the center panel by creases in the single piece of material;
the first flange being connected to the bottom edge of the center panel and extending from the rear surface of the center panel;
a clear pocket on a front surface of at least one of the first and second side panels; and
a merchandising material in the clear pocket for the beverage.

19. A method of merchandising a beverage dispenser comprising:
providing an apparatus for mounting to a beverage dispenser comprising a center panel having a bottom edge, a top edge, a first lateral edge, a second lateral edge, a front surface and a rear surface; a first side panel connected to the first lateral edge of the center panel, the first side panel extending below the bottom edge of the center panel; a second side panel connected to the second lateral edge of the center panel, the second side panel extending below the bottom edge of the center panel; and
positioning the apparatus on the beverage dispenser; and
displaying merchandising content on at least one of the center panel, the first side panel or the second side panel for a beverage dispensed by the beverage dispenser.

20. The method of claim 19 wherein the beverage dispenser is a water cooler and the merchandising content is a message to improve the desirability of consuming water as a substitute for soda and/or juice.
